(19) United States
(12) Patent Application Publication
(10) Pub. No.: US 2018/0265050 A1
(43) Pub. Date: Sep. 20, 2018

(54) Blow-Out Trailer Sweeper System

(71) Applicant: Donald Edgar Murray, JR., Spartanburg, SC (US)

(72) Inventor: Donald Edgar Murray, JR., Spartanburg, SC (US)

(21) Appl. No.: 15/457,095

(22) Filed: Mar. 16, 2017

(51) Int. Cl. B60S 3/00

(52) U.S. Cl. CPC B60S 3/008; A47L 9/08

(57) ABSTRACT

A portable device for removal of debris thats inside eighteen wheeler trailers is manufactured using various processes and materials. In one embodiment, the debris removal device includes an air hose attached to a reel encased in a weatherproof wear resistant enclosure. Because the hose connects to an air supply and spray nozzle, the enclosure has openings for access to air hose. Additionally, a fitting on each end of the air hose allows air supply and air delivery attachment advantageously eliminates sweeping which could fatigue drivers further. Accordingly, the device has lower environment impact than commonly used gas or electric leaf blowers. Permanent mounting solutions that may be desirable for trailers owners are also described herein.

Patent Claim 1. A debris removal system comprising of a trigger grip handle with a wide end air spray nozzle, 120 ft. air hose with attached glad hand coupler which will connect to air supply coupler hand located on trailer of tractor units, wherein the 120 ft. air hose is mounted on a reel, inside a weather proof, portable enclosure, mountable via bolts, suction cups and/or magnets.

### FIELD OF INVENTION

The technology relates to the general field of transportation and has certain specific applications to aid in debris removal.

### BACKGROUND

### SUMMARY

Time saving, energy saving, portable debris removal accessory.

### BRIEF DESCRIPTION OF THE DRAWINGS

FIG. 1: Illustrates a 120 ft. hose attached to a glad hand connector, trigger spray grip handle air nozzle with a wide end.

FIG. 2: Illustrates a weather proof reel box, with mounting brackets, and available magnetic or suction cup and/or bolt attachments.

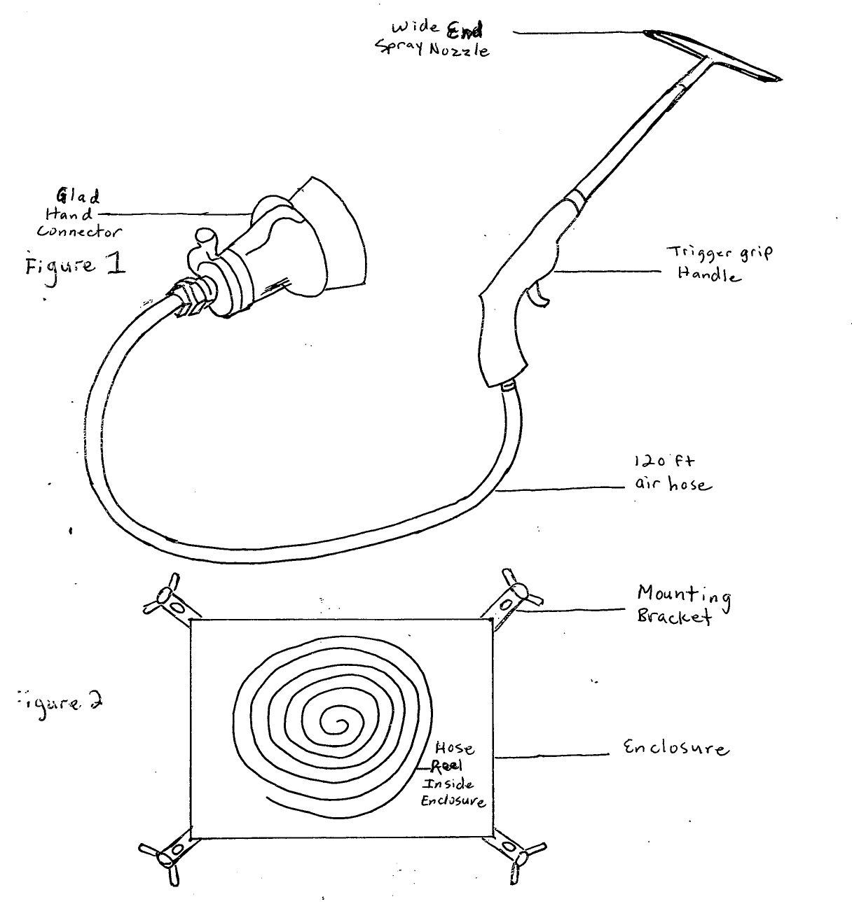

1. A debris removal apparatus comprising a trigger grip handle wide sprayer nozzle coupled to 120 ft. Flexible hose at one end of said hose a glad hand apparatus coupled at opposite end of said hose wherein said hose is assembled on reel inside mountable portable weather resistant wear resistant enclosure with hose coupler connection points accessible allowing diverse supply coupling delivery coupling attachment connectivity.

2. The apparatus of claim 1 further comprising a 120 ft. hose with coupler connection points on ends of said hose.

3. The 120 ft. hose of claim 2 further comprising of a gland hand attachment for coupling to said hose supply connection.

4. The 120 ft. hose of claim 3 further comprising a trigger grip handle wide sprayer nozzle attachment apparatus.

5. The 120 ft. hose of claim 4 wherein is assembled on reel inside mountable portable weather resistant wear resistant enclosure apparatus.

6. The 120 ft. hose of claim 5 further comprising accessible coupling points on both ends of said hose wherein there are access openings on said enclosure apparatus of claim 5.

7. The enclosure apparatus of claim 6 further comprising carrying handle wherein said enclosure is weather resistant wear resistant mountable portable.
